(19) United States
(12) Patent Application Publication
(10) Pub. No.: US 2019/0194559 A1
(43) Pub. Date: Jun. 27, 2019

(54) METHOD TO PRODUCE AN ALTERNATIVE SYNTHETICALLY DERIVED AVIATION TURBINE FUEL - SYNTHETIC PARAFFINIC KEROSENE (SPK)

(71) Applicant: THE PETROLEUM OIL & GAS CORPORATION OF SOUTH AFRICA (PTY) LTD, Cape Town (ZA)

(72) Inventors: Masikana Millan MDLELENI, Cape Town (ZA); Cyril David KNOTTENBELT, Cape Town (ZA); Janine LOURENS, Cape Town (ZA)

(21) Appl. No.: 16/329,612

(22) PCT Filed: Aug. 28, 2017
(86) PCT No.: PCT/ZA2017/050048

§ 371 Date: Feb. 28, 2019

(30) Foreign Application Priority Data
Sep. 1, 2016 (ZA) 2016/06054

(51) Int. Cl. C10G 69/12; C10G 50/00; C10G 45/44; B01J 29/40

(52) U.S. Cl. CPC C10G 69/126; C10G 50/00; C10G 45/44; C10G 2400/08; C10G 2300/4087; C10G 2300/1022; C10G 2300/1088; B01J 29/40

(57) ABSTRACT

The invention provides a process for the production of aviation turbine fuel. The process includes the steps of oligomerizing light olefins derived from a high temperature Fisher-Tropsch process over a zeolite catalyst selected from a ZSM-5 (Zeolyst Int., SiO2/A12O3≈30)(COD-9) at pressures of 50 bar with the temperature ranging from 150 to 310° C., distilling from a gasoline fraction of the oligomerisation product, a fraction boiling below 150° C., hydrogenating the distilled oligomerisation fraction over a hydrogenation catalyst, distilling from the hydrogenated hydrocarbon product, fractionating the hydrogenation distillate fraction over a fractionation catalyst and distilling the fractionation hydrocarbon product to produce an aviation turbine fuel (ASH1925) able to meet the requirements as set out for a Synthetic ISO-Paraffinic Kerosene (SPK) as per ASTM D 7566-14a.

### TECHNICAL FIELD OF THE INVENTION

This invention relates to a process for the production of two high performance synthetic aviation turbine fuels and to the composition of synthetic turbine fuels. These fuels can be used neat or as a blend stock.

### BACKGROUND TO THE INVENTION

Aviation turbine fuel has been known and used for since the end of World War II, the JP1 or Jet Propellant 1 specifications were first published in 1944. Petroleum products derived from fossil fuels have been preferred as transportation fuels because they offer the best combination of energy content, performance, availability, ease of handling and price. The long term availability of crude, intent to reduce the dependence on foreign crude, the need to diversify the energy pool combined with the desire for low emission renewable fuels provides the motivation to produce alternative fuels.

The typical process for the production of aviation turbine fuels is relatively simple and entails distilling the middle distillate, aviation turbine fuel, from crude oil and hydrotreating if required. Since crude oil is a limited natural resource and subject to depletion, a long term challenge is posed to meet the aviation industries growing needs of approximately 5% per annum. The latter places pressure on the aviation industry to diversify its fuel pool and identify alternative fuels. Ideally alternative fuels should augment or replace existing aviation turbine fuels on a permanent basis with no adverse effect on engine performance, maintenance or operational life.

The aviation industry has thus been encouraging research into the production of sustainable alternatives to conventional jet fuel, a further requirement would be that such fuels should ideally have less of a carbon footprint. This has resulted in the formation of many initiatives such as the Commercial Alternative Aviation Fuels Initiative (CAAFI) to co-ordinate multiple efforts from the fuels industry, academia and governmental research agencies.

Briefly the main requirements for sustainable alternative jet fuels are that they should:
Be compatible with conventional jet fuels and can be used in the same supply infrastructure without any special adaptation of aircraft or engines (drop-in fuel),
Meet the conventional jet fuel specifications, in particular resistance to sub-zero temperatures (Jet A: −40° C., Jet A-1: −47° C.), and have a high energy content of greater than 42.8 MJ/kg,
Meet sustainability criteria such as lifecycle carbon reductions, place less pressure on fresh water requirements for its production and not present competition for agricultural land.

### Jet A1 Development

According to CONCAWE 1995, 1999, ASTM, 2001a,b; 2002, the categories for kerosene or aviation turbine (jet fuel) not only include the finished product (fuel) but also the materials of manufacture (refinery streams) from which they are derived. The materials and manufacture section indicates that the fuel shall consist of refined hydrocarbons from conventional sources including crude oil, natural gas liquid condensates, heavy oil, shale oil and oil sands.

The generic term “kerosene” is used to describe the fraction of crude oil that boils approximately in the range of 145 to 300° C. (293 to 572° F.) and consists of hydrocarbons primarily in the range of C9-C16. Kerosene's are the lighter end of a group of petroleum substances known as middle distillates. The primary use of kerosene is as an aviation turbine fuel both for civilian (Jet A or Jet A-1) and military (JP-8 or JP-5) aircraft.

Kerosene-based fuels differ from each other in terms of performance specifications, primarily freezing point. Minor amounts of approved performance additives may be added to aviation turbine fuels, generally the concentrations of these fuel additives are not above 0.1% v/v.

### Fuel Properties of Aviation Turbine Fuels

The key function of the fuel is to provide energy to propel the aircraft. The turbine engine converts the fuels chemical energy into mechanical energy during the combustion process, thus proving forward thrust. The heat released during combustion are generically referred to as the heat of combustion (or specific energy, calorific value). The heat of combustion is determined by the energy released during the breaking of carbon-carbon and carbon-hydrogen bonds as they are converted to carbon monoxide and water. On a molecular level, Hydrogen to Carbon (H/C) ratio of the fuel plays a key role. Typically crude derived aviation fuels have an H/C of about 2, the presence of polycyclic aromatics having a H/C below 1 in the mixture will cause a lowering of the Hydrogen to Carbon Ratio.

New developments in the art proposes the use of mono-aromatics as produced in the COD process, these aromatic species have a relatively high H/C of 1.5 to 1.8. This is much higher than any other class of aromatics such as di and tri-aromatic ring compounds. For aviation fuels a high H/C ratio is preferred since they have a higher specific energy. Lower H/C ratios result in higher flame retardation, higher carbon deposition on turbines and particulate matter (black smoke).

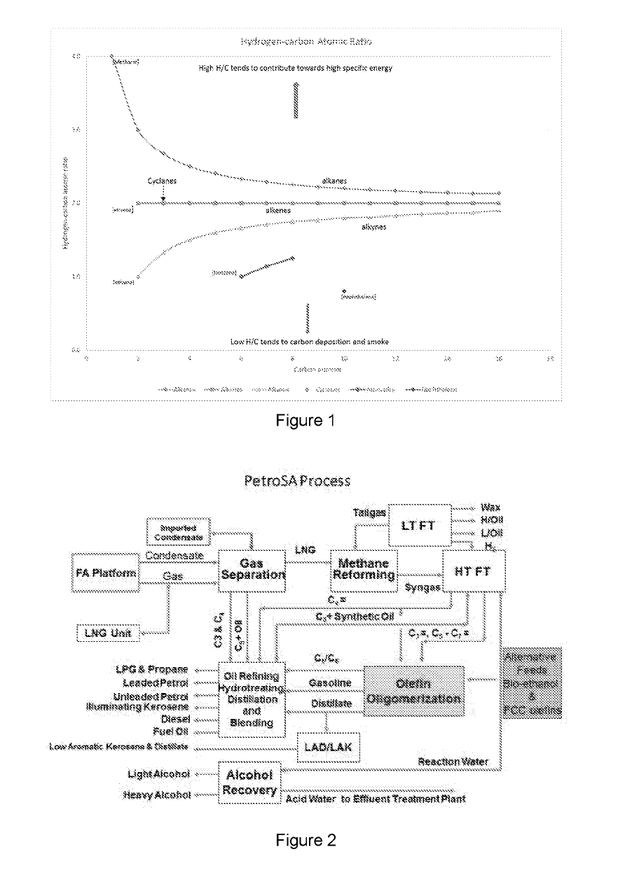

FIG. 1 illustrates the effect of hydrogen to carbon ratio for different alkane species, illustrating the effect of different hydrocarbon types on H/C ratio. As the carbon chain increases the effect of H/C ratio lowers and averages out close to 2. It should be noted that the presence of single or double methyl branches will have a higher H/C ratio compared to their straight chain alkane counterparts.

Calorific Values can be expressed as a mass or on a volume basis, this is important for aviation fuels since the fuel mass and energy density are directly impacted.

### Alternative Fuels Development

In 1999 Sasol was granted approval for the use of semi-synthetic fuel on a routine basis at O.R. Tambo International Airport (South Africa). No deleterious or negative effects were reported since its introduction from any of the engine and airframe manufactures. Based on the successful introduction of Fischer-Tropsch based fuels the aviation industry developed a generic process for the use of Fischer Tropsch (FT) synthetic fuels, blended, with conventional jet fuel in a 50:50 ratio. This was on condition that the fuel properties fell between acceptable limits. In 2009 Sasol received further approval for their patent (US 2009/0013590) specifying the use of their Low Temperature Fischer Tropsch LTFT derived fuel and blended with selected fossil derived blend stocks to ensure that all the final fuel properties were met. Since then Sasol has received FAA Certification for the use of its 100 percent synthetic fuel, this fuel incorporates aromatics that are synthetically derived as part of the FT process.

### IATA Alternative Fuels Developments

Between 2008 and 2011, at least ten airlines and several aircraft manufacturers performed flight tests with various blends containing up to 50% biojet fuel. These tests demonstrated that it was possible to synthesize biojet fuel and that it was technically sound. The following observations were made:
No modifications to the aircraft were required,
Biojet fuel could be blended with conventional fuel
The engine powered on the biojet mix even showed an improvement in fuel efficiency in some cases.

The result has been that a number of hydro processed esters and fatty acids (HEFA) fuels were certified in 2011. 19 airlines have performed over 1,500 commercial passenger flights with blends of up to 50% biojet fuel derived from used cooking oil to jatropha, camelina and algae.

### DESCRIPTION OF THE INVENTION

This invention describes a process to produce aviation turbine fuel.

The process for the production of aviation turbine fuel includes the steps of:

oligomerizing light olefins derived from a high temperature Fisher-Tropsch process over a zeolite catalyst selected from a ZSM-5 (Zeolyst Int., SiO₂/Al₂O₃≈30)(COD-9) (MFI type catalyst as defined by the International Zeolite Association (IZA) catalyst supplied by Sud Chemie at pressures of 50 bar, the temperature ranging from 150 to 310° C.;

distilling from a gasoline fraction of the oligomerisation product, a fraction boiling below 150° C.;

hydrogenating the distilled oligomerisation fraction over a hydrogenation catalyst;

distilling from the hydrogenated hydrocarbon product;

fractionating the hydrogenation distillate fraction over a fractionation catalyst; and

distilling the fractionation hydrocarbon product to produce an aviation turbine fuels able to meet the requirements as set out for a Synthetic ISO-Paraffinic Kerosene (SPK) as per ASTM D 7566-14a.

The above method may include a further hydrogenation step to produce Synthetic Iso-paraffinic (SIP) fuel with a near zero sulphur and aromatic content.

The process converts light olefins (C⁼3, C⁼4, C⁼5, C⁼6 or higher) derived from the Fischer Tropsch (FT) process to produce a longer chain distillate. The reaction takes place in a multiple fixed bed reactor system charged with a zeolite shape selective catalyst, COD-9. Multiple reactions take place almost simultaneously, the main reaction being oligomerization followed by cracking and isomerization.

An important aspect is the reaction conditions where the olefins contact with the catalyst at pressures of 50 bar, the temperature profile ranges from 150 to 310° C.

The COD reactor product comprises of a wide range of carbon 5 plus hydrocarbon products that are fractionated into gasoline and distillate, the fraction typically boiling below 150° C. reports to the gasoline pool. Once the distillate fraction is hydrogenated and further fractionated to meet the desired specification the product can then be termed as ASH 1925 or Synthetic Iso-Paraffinic Kerosene (SPK).

This SPK produced by this production route possess unique properties making it highly desirable for use as aviation turbine fuel or blend component. These bulk fuel properties include near zero Sulphur content, high energy density combined with excellent cold flow and combustion properties.

The SPK fuel produced by this route comprises mostly of iso-paraffins & cyclo-paraffins and mono-aromatic species (single ring alkyl benzenes). Thus the second aspect of this invention are the fuels exceptional cold flow properties, due to its molecular composition making it an ideal aviation turbine fuel that is fully fungible within the fuel transport systems.

The oligomerisation process acts an enabler for stand-alone refineries, in particular, synthetic fuel refineries, enabling them to convert light olefinic feedstock to distillate. Once hydrogenated and fractionated, aviation turbine fuel having favourable emission characteristics and exceptional cold flow properties is produced. The above mentioned fuel readily meets the requirements of the Standard Specification for Aviation Turbine Fuels Containing Synthesised Hydrocarbons (ASTM D7566) for Jet A and Jet A1 as well as the extended properties as defined in part 2.

The latter fuel (ASH1925 -COD Distillate) can be further processed to produce a novel alternative Synthetic Iso-paraffinic (SIP) fuel with a near zero sulphur and aromatic content. This SIP is a perfect blend material with crude derived kerosene enabling it to meet stringent aviation turbine fuel specifications that the unblended crude fuel alone could not achieve. The feedstock from the COD process once hydrogenated and fractionated is further hydrogenated to produce a SIP. This fuels meets the specifications as per ASTM D7566-14a, Table A3.1. The only exception being that the feedstock for the production of hydroprocessed synthesized iso-paraffins does not only come from plant material, it may come from FT-olefins, crude derived olefins and alcohols derived from the fermentation route of sugars or from the FT-process.

FIG. 2 provides a brief process description of the COD process fit into a GTLR including alternative feed options

As the COD distillate exits the reactor it is fractionated into the Gasoline and Distillate via a Gasoline-Distillate (GD) splitter column. The distillate boiling range can vary but typically ranges from 150 to 360° C. The raw distillate that is at this point highly olefinnic and has a Bromine Number of above 80 g Br/100 g sample.

### COD Distillate Upgrading

Distillate produced by the COD process is hydrotreated to convert the olefins to their corresponding paraffins. At this point the distillate comprises mostly of the following hydrocarbon types; n-paraffins (<10%), iso-paraffins (50 to 80%), cyclo-paraffins (5 to 30%) and mono-aromatics (3 to 15%). The distillate is highly branched. The high degree of branching was confirmed by GC×GC-MS and NMR studies. Further modelling studies show that the branching is mostly methyl groups and 1 methyl group for every 3 carbons is envisaged.

Once the product exits the hydrotreater it is fractionated into the desired fractions. At this point the product meets the detailed requirements as per ASTM D7566 for Aviation Turbine Fuels Containing Synthesised Hydrocarbons as a Synthetic Paraffinic Kerosene (SPK), lubricity being the only exception.

In a third step, further upgrading could be done to convert the mono-type aromatics to their corresponding cyclo-paraffins, where after the resultant product would meet the Synthetic Iso-paraffin (SIP) specification. The product would then comprise of only iso-paraffins and cyclic paraffins.

Table 1 highlights the hydrocarbon type composition as produced for both synthesis routes. Hydrocarbon type determination was performed by 12×12 Matrix Mass Spectrometry for both the SPK and SIP as produced.

TABLE 1

| Sample | | SPK | SIP |
|---|---|---|---|
| Prep HPLC Analysis | | | |
| Saturates | | 89.6 | 100 |
| Aromatics | | 10.4 | 0 |
| Polars | | 0 | 0 |
| 12 × 12 MS Matrix Method | | | |
| Paraffins | CnH2n+2 | 66.9 | 84 |
| Mono cyclo paraffins | CnH2n | 18.8 | 15.9 |
| Di cyclo paraffins | CnH2n−2 | 2.8 | 0 |
| Tri clyclo paraffins | CnH2n−4 | 0 | 0 |
| Tetra cyclo paraffins | CnH2n−6 | 0 | 0 |
| Total saturates | | 88.5 | 100 |
| Alkyl Benzenes | CnH2n−6 | 8.3 | 0 |
| Benzo cylo paraffins | CnH2n−8 | 3.2 | 0 |
| Benzo dicyclo paraffins | CnH2n−10 | 0 | 0 |
| Naphthalenes | CnH2n−12 | 0 | 0 |
| Acenapthenes/Biphenyls | CnH2n14 | 0 | 0 |
| Total Aromatics | | 11.5 | 0 |

While the 12×12 MS results give detail of the hydrocarbon nature of the fuel the degree of branching is not illustrated by this analytical technique.

The distillates degree of alkane branching was determined by NMR whereby a branching index of 0.8 was derived, indicating that the distillate product as synthesised is highly branched. The degree of branching, type of hydrocarbons, especially aromatics heavily impact the H/C ratio on a molecular level that directly impacts the fuel properties.

Once upgraded by hydrogenation and fractionation to a 150 to 250° C. the resultant fuel is sulphur free and has superior cold flow properties (CFPP <−45° C.) and has a relatively low aromaticity content.

### EXAMPLE 1 (ASH 1925-JP8 and SPK)

It is an object of this invention to provide synthetically derived aviation turbine fuel capable of meeting the ASTM D7566-14a, using the existing refinery configuration at the PetroSA, Mossel Bay GTLR. The resultant fuel should have excellent cold flow properties over a relatively wide boiling range, have excellent burn characteristics and not impact the flash point.

The PETROSA COD process involved contacting the olefinnic feed comprising of the following olefins; C⁼3, C⁼4, C⁼5, C⁼6 with a zeolite type catalyst (selected from the group consisting of a COD-9 catalyst and a ZSM-5 catalyst). The reactor pressure was 45 bar gauge, and a reactor feed temperature maintained such that the delta across the 3-reactors did not exceed 30° C., the temperature profile for all 3-fixed bed reactors ranged from 200 to 310° C. to produce a COD distillate.

The olefinic distillate taken from the G/D splitter was hydrogenated in a Distillate Hydrotreater (DHT) charged with a commercial cobalt molybdenum catalyst. The reaction temperature was at 280° C. at pressure was maintained 5000 to 8000 kPa. The hydrogen to hydrocarbon ratio was maintained at about 400 nm³/hr at LHSV of between 0.3 and 1. Once hydrotreated the distillate was fractionated to yield a light naphtha fraction, a kerosene mid-boiling range distillate (boiling range) and a diesel fraction boiling above 250° C.

The mid boiling range kerosene (190 to 250° C.) was further evaluated for its suitability as an aviation turbine fuel. The fuel was marked as an FT fuel and submitted to a credible independent fuels testing laboratory, DOD Jet Propulsion Laboratory under the testing code of #5290. In-house PetroSA termed the same fuel ASH1950.

TABLE 2
Results of the fuel specification testing

| | FT - 5290 | 4751 JP-8 |
|---|---|---|
| Specification Test | | |
| Total Acid Number, mg KOH/g | 0.002 | 0.003 |
| Aromatics, vol % | 5.2 | 18.8 |
| Olefins, vol % | 1.2 | 0.8 |
| Mercaptan Sulfur, % mass | 0 | 0 |
| Total Sulphur, % mass | 0 | 0.04 |
| Distillation: | | |
| IBP, ° C. | 192 | 159 |
| 10% recovered, ° C. | 200 | 182 |
| 20% recovered, ° C. | 203 | 189 |
| 50% recovered, ° C. | 212 | 208 |
| 90% recovered, ° C. | 240 | 244 |
| EP, ° C. | 264 | 265 |
| Residue, % vol | 1.2 | 1.3 |
| Loss, % vol | 0.6 | 0.8 |
| Flash point, ° C. | 71 | 51 |
| Cetane Index (calculated) | 64.9 | 46 |
| Freeze Point, ° C. | <−78 | −50 |
| Viscosity @ −20° C., cSt | 6.5 | 4.9 |
| Viscosity @ −40° C., cSt | 15.1 | 9.9 |
| Heat of Combustion (measured), BTU/lb | 18900 | 18600 |
| Hydrogen Content, % mass | 14.8 | 13.8 |
| Smoke Point, mm | 40 | 22 |
| Copper Strip Corrosion | 1a | 1a |
| Thermal Stability @ 260° C.: | | |
| Tube Deposit Rating | 1 | 1 |
| Change in Pressure, mm Hg | 0 | 2 |
| Existent Gum, mg/100 mL | <1 | 0.4 |
| API Gravity @ 60° F. | 49.8 | 44.4 |
| Specific Gravity @ 15° C. | 0.78 | 0.804 |
| Lubricity (BOCLE), wear scar mm | 0.76 | 0.53 |

It should be noted that this particular batch fuel was limited in terms of aromatic content, less than 8% v/v but still performed well over the tests. The aromatic content is further discussed later in this specification.

A comparison of the FT 5290 (ASH 1925) sample compared to JP-8 is given in Table 3.

TABLE 3
Comparison of F-T 5290 or COD (ASH1925)
sample compared to JP-8.

| | F-T | | |
|---|---|---|---|
| Properties | 5290 | JP-8 Average | JP-8 Spec |
| Paraffins (normal + iso), vol % | 90 | ~60 (+~20% | |
| | | cyclo paraffin) | |
| Aromatics, vol % (D1319) | 0 | 17.9 | ≤25 |
| Specific gravity (D4052) | 0.78 | 0.803 | 0.775-0.840 |
| Flash point, C. (D93) | 71 | 49 | ≥38 |
| Freeze point, C. (D5972) | <−78 | −51.5 | ≤−47 |
| Hydrogen content (D3343), | 14.8 | 13.8 | ≥13.4 |
| mass % | | | |
| Heat of combustion, MJ/kg | 43.9 | 43.2 | ≥42.8 |
| (D4809) | | | |
| Smoke point, mm | 40 | 23 | ≥19 |

Tables 2 and 3 indicate that the ASH 1925 fuel has a superior hydrogen content and heat of combustion as compared to JP-8 used as a reference fuel. The density is lower than the average JP-8 fuel but still within the density specification.

Aromatics as per ASTM D1319 were non-detectable on sample F-T 5290 fuel. While the a aromatic content may seem to be of some concern since a of 8% v/v aromatics is desired, aromatic synthesis in the COD process is quite controllable and it is possible produce a total mono-aromatic content of above 8% v/v by running the COD reactor inlet temperature higher. Table 4 offers the aromatic speciation as performed by the external US Testing Laboratory.

TABLE 4
Aromatic speciation of FT- 5290 (ASH 1925) compared to JP-8.

| | FT-5290 | 4751 - JP-8 |
|---|---|---|
| | F-T | JP-8 |
| D 6379 (vol. %) | FP: <−78° C. | FP: −51° C. |
| Mono-aromatics | 3.7 | 18.2 |
| Di-aromatics | <0.2 | 1.4 |
| Total Aromatics | 3.7 | 19.6 |
| Total Saturates | 96.3 | 80.4 |

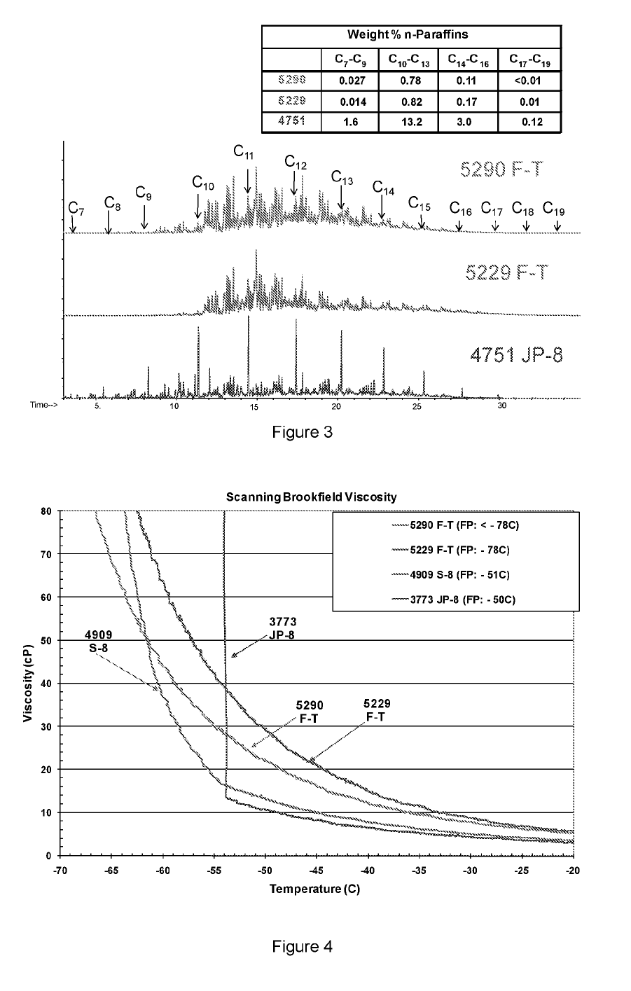

FIG. 3 provides the GC traces of the FT 5290 compared to JP-8

As can be seen in Table 3 that there is no fuel like FT-5290 since it contains almost no n-paraffins (less than 1 weight %) however all the iso-paraffins fall in the desired boiling range of C10 to C16 as with JP-8.

FIG. 4 shows a Scanning Brookfield viscometer trace of the FT 5290 fuel compared to JP-8 and other FT fuels.

(ASH 1925) has better viscosity properties than traditional JP-8 where with the JP-8 fuel the viscosity drops away at a temperature of near −55° C., its freeze point temperature. While the PetroSA ASH 1925 viscosity at 40° C. is 15.1 cP, higher than the JP-8, the ASH 1925 (FT 5290) remained in the liquid until state beyond −70° C.

As can be seen in latter example, the fuel tested at the US Jet Propulsion Laboratory compared well with the JP-8 fuel, the exception being that of aromatic content. The fuel clearly was more resilient in terms of cold flow properties, with a freeze point of <−78° C., a high hydrogen content of 14.8% mass, good oxidation stability and a superior calorific value. From the latter it is clear that the ASH 1925 (FT 5290), is well suited as a reliable alternative aviation turbine fuel used neat or as a blend component.

### EXAMPLE 2 (COD Kerosene-SPK)

Light olefins in the carbon range C3 to C6 originating from a High Temperature Fischer Tropsch (HTFT) plant located in Mossel Bay were oligomerised over a proprietary zeolyte catalyst (COD 9). The oligomerisation reaction was performed at moderate temperatures below 300° C. and at relatively high pressures of 45-bar process for the oligomerisation reaction to produce an olefinic distillate with a Bromine Number of over 90 g Br/100 g sample. The olefinic portion of the sample was hydrotreated at moderate hydrotreating conditions in Diesel Hydrotreater unit (Unit 35) equipped with a cobalt molybdenum catalyst, at 58 kPa, the WABT did not exceed 321 ° C., the LHSV was maintained at 0.6 while the Hydrogen to Hydrocarbon Ratio was 275. A hydrotreated fraction boiling between about 190 to 250° C. was collected.

SPK samples from the GTLR test run were tested for verification of the hydrocarbon types. HPLC, 12×12 MS and GC-FI MS characterisation techniques were used. The results thereof are given in Table 5.

It was clear that the plant could be run in a higher aromatic mode and that the aromatic type was still mono-aromatic species. The aromatic species being mono-aromatics was important since these species have a better H/C ratio than any other aromatic. Further it was important to confirm the absence multiple ring aromatics that do not have a favourable impact on H/C ratio, and are deemed as carcinogens.

A lower H/C ratio results in higher calorific values for the fuel, have better combustion properties and have a lower smoke point. A production sample was tested for hydrocarbon type composition and aromatic content by GC-FI MS, the presence of single ring aromatics was confirmed. This is illustrated in Table 5.

TABLE 5
GC-FI MS of ASH 1925
ASH 1925
Z Number

| | +2 | 0 | −2 | −4 | −6 | −8 | −10 |
|---|---|---|---|---|---|---|---|
| Carbon | CnH2n + 2 | CnH2n | CnH2n − 2 | CnH2n − 4 | CnH2n − 6 | CnH2n − 8 | CnH2n − 10 |
| Number | Alkanes | 1-CycloA | 2-CycloA | 3-CycloA | Alk-Benz | BenCycl | BendiCyc |
| 10 | 2.74 | 0.86 | 0.09 | 0.10 | 1.32 | 0.02 | 0.00 |
| 11 | 10.26 | 2.18 | 0.16 | 0.00 | 1.34 | 0.06 | 0.00 |
| 12 | 16.46 | 3.35 | 0.42 | 0.03 | 1.91 | 0.30 | 0.00 |
| 13 | 14.93 | 3.46 | 0.82 | 0.00 | 1.80 | 0.27 | 0.03 |
| 14 | 11.75 | 3.07 | 0.62 | 0.04 | 1.21 | 0.28 | 0.07 |
| 15 | 6.89 | 2.58 | 0.46 | 0.03 | 0.64 | 0.19 | 0.00 |
| 16 | 3.23 | 1.36 | 0.32 | 0.04 | 0.35 | 0.16 | 0.00 |
| 17 | 1.53 | 0.70 | 0.13 | 0.00 | 0.16 | 0.06 | 0.00 |
| 18 | 0.34 | 0.25 | 0.08 | 0.00 | 0.04 | 0.00 | 0.00 |
| 19 | 0.12 | 0.13 | 0.03 | 0.00 | 0.00 | 0.02 | 0.00 |
| 20 | 0.03 | 0.00 | 0.00 | 0.00 | 0.00 | 0.00 | 0.00 |
| 21 | 0.03 | 0.00 | 0.00 | 0.00 | 0.00 | 0.00 | 0.00 |
| 22 | 0.02 | 0.00 | 0.00 | 0.00 | 0.00 | 0.00 | 0.00 |
| Totals | 68.32 | 17.97 | 3.15 | 0.24 | 8.77 | 1.35 | 0.14 |

Having confirmed the presence of aromatics in some detail it was decided to confirm the level of isomerisation of the paraffin species, multidimensional GC×GC-TOF MS was selected as analysis technique. A high ratio of normal-paraffins to iso-paraffins was confirmed and illustrated as can be seen in Table 6. The ratio of normal to iso-alkanes was 0.49 to 70.64. This high degree of branching contributes to the fuels unique hydrocarbon type composition.

TABLE 6
GC × GC TOF MS of ASH 1925
ASH 1925

| Carbon | | | | | | | |
|---|---|---|---|---|---|---|---|
| Number | n-Alk | Iso-Alk | cyclic-Alk | Di-Cyclic-Alk | Tri-Cyclic-Alk | Aromatics | Naphth |
| 9 | 0.00 | 0.02 | 0.03 | 0.00 | 0.00 | 0.10 | 0.00 |
| 10 | 0.04 | 0.42 | 0.41 | 0.01 | 0.00 | 0.66 | 0.00 |
| 11 | 0.26 | 1.91 | 1.35 | 0.08 | 0.00 | 1.50 | 0.00 |
| 12 | 0.09 | 5.34 | 3.46 | 0.23 | 0.01 | 2.05 | 0.00 |
| 13 | 0.06 | 9.47 | 5.87 | 0.33 | 0.00 | 1.98 | 0.00 |
| 14 | 0.01 | 13.79 | 3.12 | 0.06 | 0.01 | 1.38 | 0.00 |
| 15 | 0.01 | 31.20 | 1.89 | 0.02 | 0.00 | 0.78 | 0.00 |
| 16 | 0.00 | 5.81 | 1.17 | 0.32 | 0.00 | 0.41 | 0.00 |
| 17 | 0.00 | 1.84 | 0.51 | 0.04 | 0.00 | 0.12 | 0.00 |
| 18 | 0.00 | 0.67 | 0.11 | 0.02 | 0.00 | 0.02 | 0.00 |
| 19 | 0.00 | 0.17 | 0.03 | 0.00 | 0.00 | 0.00 | 0.00 |
| 20 | 0.00 | 0.00 | 0.00 | 0.00 | 0.00 | 0.00 | 0.00 |
| 21 | 0.00 | 0.00 | 0.00 | 0.00 | 0.00 | 0.00 | 0.00 |
| 22 | 0.02 | 0.00 | 0.00 | 0.00 | 0.00 | 0.00 | 0.00 |
| Totals | 0.49 | 70.64 | 17.95 | 1.11 | 0.02 | 9.00 | 0.00 |

The hydrocarbon type analyses having been validated on a molecular level the physical properties of the fuel against the ASTM specification were tested. Table 7 compares the ASTM detailed requirement for Synthesized Hydrocarbons (SPK) for use in aviation turbine fuels Part 1, these requirements are readily met.

Tests performed on various samples produced from this process for trace metals by test method ASTM D3605, for Sodium, Potassium, Lead, Calcium, Lithium and Vanadium, were below the methods detection limit.

TABLE 7
ASTM 7566 - Part 1 Specification versus ASH1925 (SPK)
Detailed Requirements of Aviation Turbine Fuels
Containing Synthesized Hyrocarbons
Part 1 - Basic Requirements

| | | | | SPK |
|---|---|---|---|---|
| | | Jet A or | | (ASH |
| Property | Unit | Jet A1 | Test Method | 1925) |
| COMPOSITION | | | | |
| Appearance | | C & B | | C & B |
| Acidity, Total | mg KOH/g | Max. 0.015 | D3242 IP 354 | 0.002 |
| Aromatics | vol % | Max. 25.0 | D1319/IP 156 (IP 391) | 9 |
| or Total Aromatics | vol % | Max. 26.5 | D6379/IP 436 | |
| Sulphur, Total | wt % | Max. 0.30 | D1266, D1552, D5453 | <0.001 |
| Sulphur, Mercaptan | wt % | Max 0.0030 | D3227/IP342 | <0.001 |
| or Doctor Test | | Negative | D4952 | Neg |
| VOLATILITY | | | | |
| Distillation Temperature: | | | | |
| Initial BP | ° C. | Report | D86, D2887/IP 406 | 191 |
| 10% Recovery | ° C. | Max. 205 | | 196 |
| 50% Recovery | ° C. | Report | | 207 |
| 90% Recovery | ° C. | Report | | 241 |
| Final BP | ° C. | Max. 300 | | 250 |
| Distillation Residue | vol % | Max. 1.5 | | 1.1 |
| Distillation Loss | vol % | Max. 1.5 | | 0.5 |
| Flash Point | ° C. | Min. 38 | D56 or D 3828, IP170 | 71 |
| Density @ 15° C. | kg/m3 | 775-840 | D1298/IP 160 or D4052 | |
| Density @ 20° C. | kg/m3 | 771.3-836.6 | D1298/IP 160 or D4052 | 0.7787 |
| FLUIDITY | | | | |
| Freezing Point | ° C. | Max. −40 (Jet A) | D2386/IP 16, D5972/IP435 | <−78 |
| Viscosity @ −20° C. | cSt or (mm²/s) | Max. 8.0 | D445/IP 71 | 6.5 |
| COMBUSTION | | | | |
| Net Heat of Comb. | MJ/kg | Min. 42.8 | D4529, D3338, D4529 | 46.7 |
| Smoke Point | mm | Min. 25 | D1322/IP 57 | 44 |
| or Smoke Point | mm | Min. 19 | D1322/IP 57 | |
| and Naphthalenes | vol % | Max. 3.0 | D1840 | |
| CORROSION | | | | |
| Copper Strip | 2 h @ 100° C. | Max. 1 | D130/IP 154 | 1a |
| THERMAL STABILITY | | | | |
| JFTOT ΔP @ 260° C. | mm Hg | Max. 25.0 | D3241/IP 154 | 0 |
| Tube Deposit Rating | Visual | Max. <3 | | 1 |
| CONTAMINANTS | | | | |
| Existent Gum | mg/100 m | Max. 7 | D381, IP 540 | <1 |
| MSEP Rating | | 7 | D3948 | |
| Fuel without Condt. Add | | Min. 85 | | Not Tested |
| Fuel with Condt. Add. | | Min. 70 | | Not Tested |
| OTHER | | | | |
| Conductivity | pS/m | 50-450 | D2624/IP 274 | |
| Lubricity (BOCLE) | diameter, mm | Max. 0.85 | D5001 | 0.76 |
| ADDITIVE | | | | |
| Electrical conductivity | mg/L | 17.0-24.0 | | |

TABLE 8
ASTM 7566 - Part 2 Extended Requirements versus ASH1925 (SPK)
Part 2 - Extended Requirements

| | | | | SPK |
|---|---|---|---|---|
| | | Jet A or | | (ASH |
| Property | Unit | Jet A1 | Test Method | 1925) |
| COMPOSITION | | | | |
| Aromatics (either) | vol % | Min. 8 | D1319/IP | |
| | | | 156 (IP 391) | |
| or Total Aromatics | vol % | Min. 8.4 | D6379/IP 436 | 9 |
| VOLATILITY | | | | |
| Distillation | | | D2887/IP | |
| | | | 406, D2887 | |
| T50 − T10 | ° C. | Min. 15 | | |
| T90 − T10 | ° C. | Min 40 | | |
| LUBRICITY | | | | |
| Lubricity | mm | Max. 0.85 | D5001 | 0.76 |
| FLUIDITY | | | | |
| Viscosity @ −40° C. | cSt or | Max. 12 | D445/IP 71 | 15.1 |
| | (mm²/s) | | | |

Table 8 indicates the extended Requirement as given in ASTM 7566-14a where a minimum aromatic content of 8 vol % is required is met. The only exception to meeting all the stringent requirements has been the requirement to have a viscosity of lower than 15.1 cSt at −40° C. It should be noted that from FIG. 3, the Scanning Brookfield viscometer trace, the FT 5290 fuel compared to JP-8 and other FT fuels showed that the SPK fuel provided remains in the liquid form without freezing to beyond −78° C.

The physical properties in Table 7 further illustrate that the requirements of MIL-DTL-83133F (JP-8) Synthetic Paraffinic Kerosene (SPK) to be used either neat or in blends up to 50% v/v can be achieved. A flash point of 71° C. for the SPK where the desired military specification is 68° C. minimum, this is not seen as a problem since a small reduction in the distillation cut point will reduce the IBP, Flash Point and viscosity at −40° C.

### EXAMPLE 3

Light olefins in the carbon range C3 to C6 originating from the High Temperature Fischer Tropsch plant located in Mossel Bay were oligomerised over a proprietary zeolyte catalyst (COD 9). The oligomerisation reaction took place at moderate temperatures below 280° C. and relatively high pressures of 55 bar process were used for the oligomerisation reaction to produce an olefinic distillate with a Bromine Number of over 120 g Br/100 g sample.

This distillate was further hydrotreated in one step using a supported Platinum commercial catalyst (Axens LD402). The catalyst (270 cc) was charged into a pilot plant a graded bed format and diluted with inert ceramics. The reactor pressure was maintained at 60 bar, the WABT did not exceed 230° C., the LHSV was maintained at 0.9 and a portion of the product was recycled.

The one step hydrotreated distillate was fractioned by means of a true boiling point distillation apparatus to yield a kerosene fraction in the boiling range 170° C. to 250° C. This kerosene was found to contain less than 0.1% v/v aromatics.

The above process delivered a ready to go Synthetic Iso-paraffin (SIP) Jet A1 kerosene, the properties thereof are given in Table 9.

TABLE 9
Physical properties of Mosspar 1925 (Synthetic Iso-Paraffin)

| Properties | Units | Test Method | Result |
|---|---|---|---|
| Density @ 20° C. | Kg/L | ASTM D 4052 | 0.7705 |
| Flash Point (PMcc) | ° C. | ASTM D 93 | 66.5 |
| Total Sulphur | ppm | ASTM D5453 | <0.3 |
| | (m/m) | | |
| Colour (Saybolt) | | ASTM D156 | 30 |
| Aromatic content | % m/m | UOP 495 | <0.01 |
| Kinematic viscosity @ | cSt | ASTM D 445 | 1.878 |
| 25° C. | | | |
| Brookfield Viscosity @ | cP | | 2.960 |
| 0° C. | | | |
| Heat of Combustion | kJ g⁻¹ | | 46.67 (0.1457) |
| Distillation: | | ASTM D86 | |
| IBP | ° C. | | 189.7 |
| 10% v/v | ° C. | | |
| 20% v/v | ° C. | | |
| 50% v/v | ° C. | | |
| 90% v/v | ° C. | | 232.7 |
| FBP | ° C. | | 249.2 |
| Distillation Residue | ml | | 0.8 |

The biodegradability of the resultant fuel Mosspar 1925 (SIP) was tested in a closed bottle test, on day 21, 91.6% of the product had degraded indicating that this product is readily biodegradable.

Further to the above testing it was found that the SIP, Mosspar 1925, displayed a low toxicity towards Mysid Shrimp (Mysidopsis bahia) in a 96-Hour toxicity test as per OCSPP 850.1035, the no observed effect concentration was greater than 2000 mg/L. Further testing on 48-Hour acute toxicity testing on Daphnia magna as per OECD 202 and Fathead Minnow (Pimephales promelas) (OECD 203) indicated that the NOEC was 100 mg/l for these organisms indicating limited toxicity.

The ratio of iso-paraffins to normal paraffins for the SIP fuel is extremely high (nP:iP::2:88), this is characteristic of this process and resultant streams.

As previously mentioned a high H/C ratio is favoured for aviation fuels since the specific energy would resultantly be higher. Lower H/C ratios result in higher flame radiation that in turn increase carbon deposits and particulate matter (smoke). Typical crude derived fuels have an H/C ratio of about 2. The main driver for low H/C ratios are aromatics especially multiple rings, it is interesting to note that while the COD derived diesel contain aromatics these are all mono or single ring aromatics. Mono-aromatics (alkyl- benzenes) have lower H/C ratio than other aromatic species, 1.5 to 1.8.

According to the Jet Fuel specification, MIL-DTL-83133F, JP-8 should have a boiling range of between 157 and 300° C. and a density at 15° C. ranging from 0.775 to 0.840 kg/l making both the proposed SPK (ASH1925) and the SIP (Mosspar 1925) fuels as produced in the GTLR (Mossel Bay) highly desirable as aviation turbine fuels.

In terms of cold flow properties the SPK has a Freeze Point of <−78° C. while the SIP and SPK have Cloud Point of well below −40° C. indicating that they are safe to use at high altitudes without any fear of in-line freezing. In the prior art, increased cooling of crude derived fuels after the 1^{st} crystallisation point (Cloud Point) typically result in a sharp rise in viscosity, with wax crystals evolving and limiting fuel flow. The presence of wax crystals can deposit on the fuel delivery system inner walls blocking in-line filters and injector nozzles leading to catastrophic failure. A Freeze Point of −47° C. is thus important for long haul flights.

The fuels derived from the COD process, ASH1925 and Mosspar 1925 tend to be low polar boundary solvents content (no heteroatoms) so have limited lubricity, these fuels are however compatible with the approved lubricity and electrical conductivity additives.

Disclosed are two processes to manufacture safe and reliable alternative fuels with superior combustion qualities. The proposed fuels in the new art are compatible with conventional fuels and would not require additional storage and logistics facilities. Both the SPK and SIP have high Specific Energy, of 46.6 and 46.7 MJ/kg. Converting the Specific Energy to Energy Density the value is in excess of 35 MJ/L not only making them comparable Jet A/Jet A1 but improve on the prior art energy density.

Due to the fact that they are by nature low in aromatic content they do not tend to form smoke or carbon deposits.

The proposed fuels are low in existent and potential gums, the presence of gum was tested by ASTM D381 and found to be well within specification. The fuels have low portions of olefins in them that are responsible for gum and polymer formation, olefins are reactive in fuel and as such recommendations are to have not more than 5% olefins in aviation turbine fuels. The SPK and SIP show good resistance to oxidation, oxidised fuels containing gum will tend to deposit as lacquer films (varnish) on the turbine blades that can distort fuel spray patterns and even shear off resulting in turbine damage. While the Bromine Number of the SPK (ASH1925) is below 10 g Br/100 g sample GC-MS characterisation indicates the absence of olefins, both fuels are hydrogenated. In terms of thermal stability the fuels are stable over long periods of time.

The proposed fuels are virtually free of both sulphur and nitrogen compounds thereby reducing undesirable emissions. Studies performed on vehicles using fuels derived from the COD process have proven over a wide range of test conditions that they are able to simultaneously reduce both particulate matter (smoke) and nitrous oxide emissions.

The COD fuels ASH1925 and Mosspar1925 are free of poly-aromatic hydrocarbons that contribute to particulate matter and deemed carcinogenic. Fuels with high aromatic contents cause fuel delivery system elastomers to swell, however exposing the fuel to a fuel with lower aromatic content could lead to a reduction in elastomer swell and result in leakages. It is for this reason that the Mosspar1925 fuel that contains <0.01% m/m aromatics to be used a blend stock to upgrade fuels with less desirable properties.

The ASH1925 fuel contains sufficient aromatics, >8% m/m mono-aromatics to meet the Jet A/Jet A1 and JP-8 aromatic specifications. Of interest the mono-aromatic species while assisting to improve density and combat reductions in seal swell after expose to high aromatic containing fuels the mono-aromatic compounds offer the best in class hydrogen to carbon ratio.

Provided is a homologous series of iso-paraffinic and cyclic hydrocarbons across the carbon range in the carbon range C10 to C20, the ratio of iso to normal paraffins being at least 10:1 but most likely 40:1.

The invention provides a process to produce synthetically derived aviation turbine fuels by catalytic conversion of light Fischer Tropsch olefins to distillates (COD) and refining thereof. The production of synthesized iso-paraffins (SIP) and synthesised paraffinic kerosene (SPK) that can be both be used as aviation turbine fuels as a blend component or a fungible drop in component.

Provided is a process to produce a synthesized iso-paraffins (SIP) (M1925) comprising essentially of iso-paraffins and cyclo-paraffins that can be used as a semi-synthetic aviation turbine fuel blend component in a 50:50 blend ratio.

In addition to providing a process for the provision of SIP's also provided is a process for producing synthesised paraffinic kerosene (SPK) (ASH1925) that meets the requirements of ASTM D7566 as a fungible turbine fuel.

The process entails both oligomerisation and isomerisation of Fischer Tropsch derived, or other light olefins, to form hydrocarbons in the distillate boiling range. The reaction takes place over a shape selective zeolyte type catalyst at temperatures of 150 to 320 ° C. and reactor pressures of 5,5 MPa. Distillate can then be refined by hydrogenation to yield ASTM D7566 compliant SPK. Further processing of resulting the SPK to hydrogenate aromatics to their corresponding cyclo-paraffins yields a SIP.

1. A process for the production of aviation turbine fuel includes the steps of:
oligomerizing light olefins derived from a high temperature Fisher-Tropsch process over a zeolite catalyst selected from a ZSM-5 (Zeolyst Int., SiO₂/Al₂O₃≈30)(COD-9) (MFI type catalyst as defined by the International Zeolite Association (IZA) catalyst supplied by Sud Chemie at pressures of 50 bar, the temperature ranging from 150 to 310° C.;
distilling gasoline fraction from the oligomerisation product, a fraction boiling below 150° C.;
hydrogenating the distilled oligomerisation fraction over a hydrogenation catalyst;
distilling from the hydrogenated hydrocarbon product;
fractionating the hydrogenation distillate fraction over a fractionation catalyst; and
distilling the fractionation hydrocarbon product to produce an aviation turbine fuel (ASH1925) able to meet the requirements as set out for a Synthetic ISO-Paraffinic Kerosene (SPK) as per ASTM D 7566-14a.

2. An aviation turbine fuel process as claimed in claim 1, wherein the ASH1925 aviation turbine fuel is further processed by further hydrogenation to produce a Synthetic Iso-paraffinic (SIP) comprising only iso-paraffins and cyclic paraffins and selecting the feedstock for the production of hydroprocessed synthesized iso-paraffins from plant material, FT-olefins, crude derived olefins and alcohols derived from the fermentation route of sugars or from a FT-process.

3. (canceled)

4. An aviation turbine fuel process as claimed in claim 1, wherein the oligomerization reaction takes place in a multiple fixed bed reactor system charged with a zeolite shape selective catalyst.

5. An aviation turbine fuel process as claimed in claim 2, wherein the SPK fuel produced comprises mostly of iso-paraffins & cyclo-paraffins and mono-aromatic species (single ring alkyl benzenes).

6. An aviation turbine fuel process as claimed in claim 2, the fuel (ASH1925-COD Distillate) is further processed, hydrogenated and fractionated, to produce an alternative Synthetic Iso-paraffinic (SIP) fuel with a near zero sulphur and aromatic content.

7. An aviation turbine fuel process as claimed in claim 2, wherein the SIP is used as a blend material with crude derived kerosene.

8. An aviation turbine fuel process as claimed in claim 1, after hydrogenation, the distillate comprises mostly of the following hydrocarbon types; n-paraffins (<10%), iso-paraffins (50 to 80%), cyclo-paraffins (5 to 30%) and mono-aromatics (3 to 15%).

9. An aviation turbine fuel process as claimed in claim 1, which includes the step of further deep hydrogenation to hydrogenate the mono-type aromatics to their corresponding cyclo-paraffins the fuel comprising of only iso-paraffins and cyclic paraffins.
